(19) United States
(12) Patent Application Publication
(10) Pub. No.: US 2006/0107259 A1
(43) Pub. Date: May 18, 2006

(54) Communication interface for use in personal computer

(75) Inventors: Fan-Sheng Lin, Taipei City (TW); Sung-Chin Shen, Taipei City (TW)

Correspondence Address: BIRCH STEWART KOLASCH & BIRCH, PO BOX 747, FALLS CHURCH, VA, 22040-0747, US

(73) Assignee: ETROVISION TECHNOLOGY

(21) Appl. No.: 11/320,817

(22) Filed: Dec. 30, 2005

Related U.S. Application Data
(63) Continuation-in-part of application No. 10/928,090, filed on Aug. 30, 2004.

(30) Foreign Application Priority Data
Oct. 28, 2005 (TW) 094137967

(51) Int. Cl. G06F 9/44; G06F 9/445

(52) U.S. Cl. 717/169; 717/175

(57) ABSTRACT

A communication interface for use in a personal computer is provided, which is electrically connected to a chip set in a personal computer, and is used for obtaining system information in the personal computer through a shared memory, and recording the system information in a storage memory, displaying files and programs stored inside by simulating the storage memory as a MSC (Mass Storage Class) disk, and also accessing internal data and executable programs in the storage memory by connecting with the communication interface from an external computer.

### CROSS-REFERENCE TO RELATED APPLICATIONS

This application is a continuation-in-part patent application of U.S. application Ser. No. 10/928,090 filed on Aug. 30, 2004, it claims priority under 35 U.S.C. § 119(a) on Patent Application No(s). 094137967 filed in Taiwan, R.O.C. on Oct. 28, 2005, the entire contents of which are hereby incorporated by reference for which priority is claimed under 35 U.S.C. § 120.

### BACKGROUND OF THE INVENTION

1. Field of the Invention

The present invention relates to a communication interface, and more particularly, to a communication interface for accessing shared data in a local terminal from an external computer terminal or the local terminal.

2. Related Art

In recent years, along with the high level of development of information product technology, we begin to enter an era in which information products are popularized, and especially in the personal computer, which has already become a necessity for each family. Through use of the computer, we may look up data on the Internet, receive and send e-mails, watch video discs, listen to music, and play computer games. To perform the above functions, the OS (Operating System) and various application programs installed in the computer are needed. However, as long-term use of the personal computer, the more driver programs and resident programs will be installed the longer time will be needed to start up the system and load software.

The problem of time-consuming and inconvenience when booting up the personal computer not only influences the efficiency of and impression on the end-user but also greatly affects the product inspection of the distribution system and the product examination and repair of the customer service division. For example, if a service engineer needs to deal with a personal computer sent in for repair, the engineer should first determine the model and outfit of the machine, then find out the serial number and warranty information of the machine, and further examine the important abnormal record and software/hardware features. If all these data can be obtained only after booting up the computer, it will spend a lot of time and labor cost, such that the processing manner cannot be easily automated and it will also significantly influence the quality of customer service.

In the past, a device applied in an embedded system was disclosed, which makes the computer system not only transmit data by a USB (Universal Serial Bus) interface, but also convert the memory in the embedded system device to an MSC (Mass Storage Class) interface on the computer system, and users may thus access the data in the memory directly. If such a mechanism may be used to access the specification data, manufacturing time, and warranty status of the internal device of the computer and record important messages and data during operation, the problem described above can be solved via a USB without booting up the system.

### SUMMARY OF THE INVENTION

In view of the above problem, an object of the present invention is to provide a communication interface for use in a personal computer, which can be added without changing the system architecture of the elements on the motherboard, so as to collect and record the system information in the personal computer, and store various programs needed when installing to the personal computer, and enable users to know the device information of the computer system quickly by service programs stored inside which may be executed automatically.

Therefore, to achieve the above object, the present invention discloses a communication interface for use in a personal computer, and the communication interface in the most preferable embodiment partly may include:

a storage memory, for storing the system information and various program files of the personal computer;

an I/O (Input/Output) control chip communicating with the computer via the connection of a USB (Universal Serial Bus), for simulating the storage memory as an MSC (Mass Storage Class) disk on the personal computer, and activating the service programs stored in the storage memory, obtaining system information of the personal computer and event log messages (for example, warning and error messages) actively, and storing them in the storage memory, when the system information display service is activated; and

a USB switch adaptor, with one end being electrically connected to a USB module in the personal computer, and the other end being electrically connected to a slave socket, one of which is selected as a communication medium according to a truth table.

Through the present invention, the device information of a computer system may be obtained from the slave socket on the casing of a computer via the connection of a USB cable, without opening the packaging of or booting up the sold computer, and also the system information of the personal computer may be displayed at the local terminal by pressing a service hotkey after the user boots up the computer.

The features and implementations related to the present invention will be illustrated in detail in the most preferable embodiment with reference to the accompanying drawings as follows.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a systematic architectural view according to a first embodiment of the present invention;

FIG. 2 is a systematic architectural view according to a second embodiment of the present invention;

FIG. 3 is a schematic view of a personal computer and an external computer connected by a USB cable according to the present invention;

FIG. 4 is a schematic view of the data stored in a storage memory according to the present invention;

FIG. 5 is a systematic architectural view according to the most preferable embodiment of the present invention;

FIG. 6 is a flow chart of displaying a system information display screen when a computer loads an operating system according to the present invention;

FIG. 7 is a schematic view of a system information display screen when a computer loads an operating system according to the present invention;

FIG. 8 is a schematic view of software architecture on an external computer according to the present invention; and

FIG. 9 is a schematic view of a truth table according to the present invention.

### DETAILED DESCRIPTION OF THE INVENTION

The present invention will disclose a communication interface for use in a personal computer. In the following detailed illustration of the present invention, many particular details will be described to provide an entire illustration of the present invention. However, those skilled in the art can implement the present invention without using these particular details, or can implement the present invention by using alternative elements or methods. In other cases, known methods, programs, parts, and circuits will not be illustrated in detail to avoid unnecessary confusion regarding the emphases of the present invention.

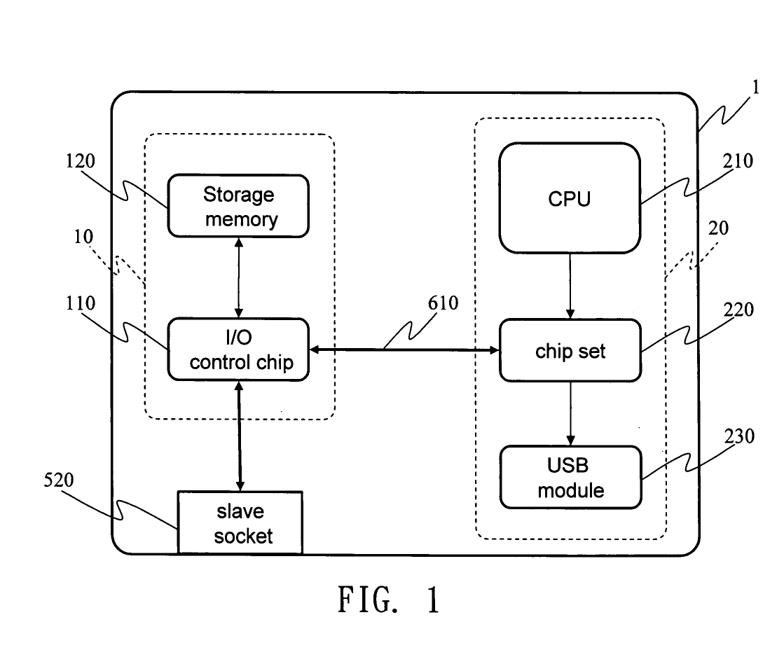

Referring to FIG. 1, it is a systematic architectural view according to a first embodiment of the present invention. Previously a product-bundled program 125 of the machine would be attached when a personal computer 1 was sold, and these discs contained the product-bundled program 125 were needed for reinstalling the system whenever the operating system of the personal computer 1 is failed. If the discs were misplaced and could not be found, the user may obtain the program through a network connection or another way, but it is extremely inconvenient by this way. Therefore, to solve such a problem, a communication interface 10 electrically connects to outside a motherboard 20, wherein an I/O control chip 110 electrically connected to a chip set 220 via a first bus 610 is provided. When the personal computer 1 has been booted up, the data in a storage memory 120 may be displayed on the personal computer 1 through the I/O control chip 110 via the first bus 610, such that the desired files and programs may be found easily and the device information and error messages on the computer may be recorded in the storage memory 120 of the communication interface 10.

The storage memory 120 is typically a non-volatile memory. As the data are stored in a non-volatile memory, the problem of data losing due to turning off the computer is no longer existed, The non-volatile memory includes the following types: EEPROM (Electrically Erasable Programmable Read-Only Memory), EPROM (Erasable Programmable Read-Only Memory), or Flash memory, such as NAND type flash memory and NOR type flash memory.

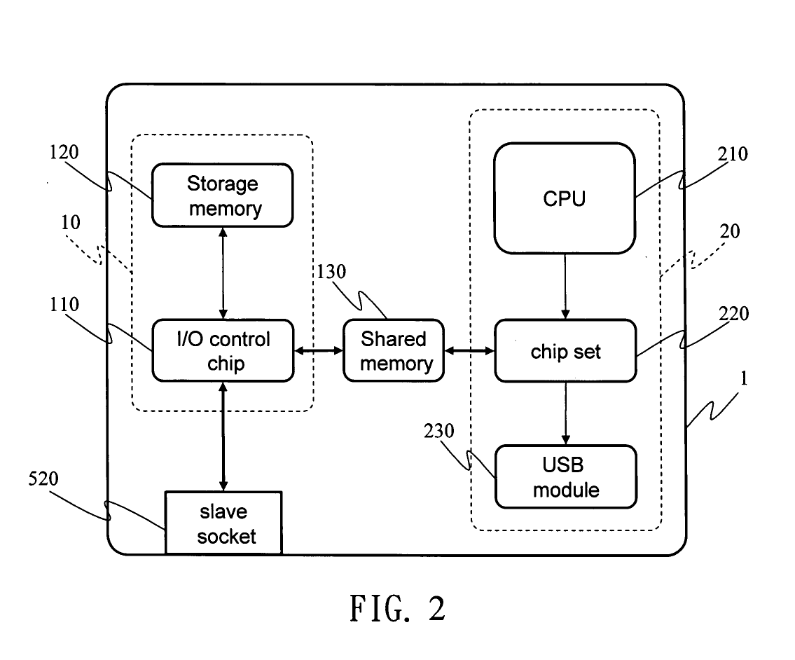

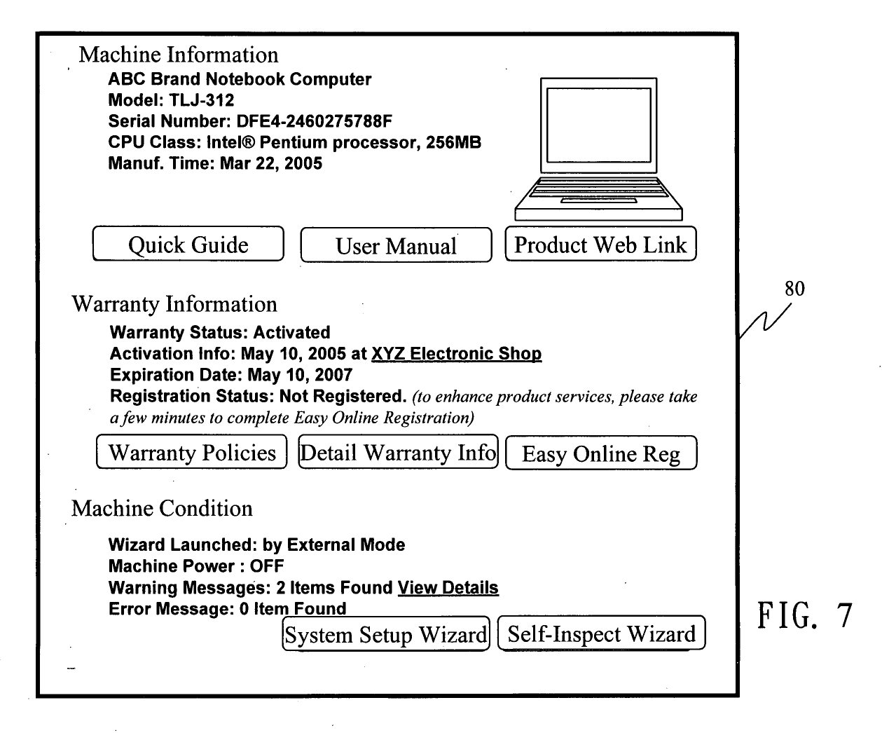

However, in the method of the first embodiment with regard to the circuit design of the personal computer 1, one must consider the internal power supply of the communication interface 10; it cannot become an independently operating interface, thereby increasing the integral circuit design difficulty of the personal computer 1, and also the power supply of the local terminal may operate only when activated. For this reason, a second embodiment is provided. Referring to FIG. 2, it is a systematic architectural view according to the second embodiment of the present invention, the difference from FIG. 1 lying in that a shared memory 130 is added between the I/O control chip 110 and the chip set 220 as a communication medium between them. The shared memory 130 is a serial interface ROM, and the storage memory 120 is typically a parallel interface ROM with a relatively large capacity. Due to its small data size, the system information of the personal computer 1 may be stored in a shared memory 130 after being examined and obtained by the CPU (Central Process Unit) 210 of the motherboard 20; when the system information display service is activated by the personal computer 1 at a local terminal, the system information may be loaded by the I/O control chip 110 and displayed on the system information display screen 80 (as shown in FIG. 7). When the I/O control chip 110 discovers that the system information recorded in the shared memory 130 is different from the one in the storage memory 120, the system information of the personal computer 1 stored in the storage memory 120 is then updated.

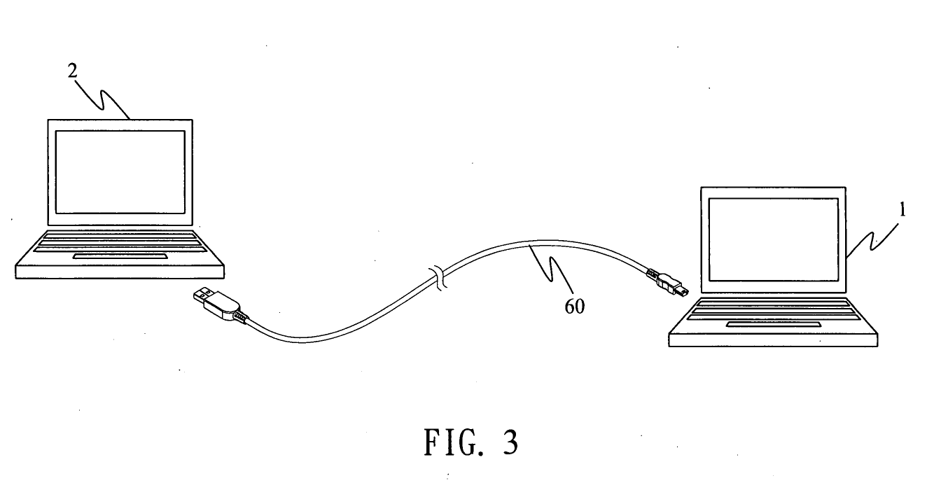

Furthermore, in order that the system information in the personal computer 1 may be read and modified without booting up the personal computer 1, as shown in FIG. 3, the storage memory 120 is simulated as a MSC (Mass Storage Class) disk on an external computer 2 via a slave socket 520 by a USB (Universal Serial Bus) cable 60, and since the power supply may be obtained from the external computer 2 through the USB interface, files can be read from the storage memory and written into the storage memory directly from the external computer 2.

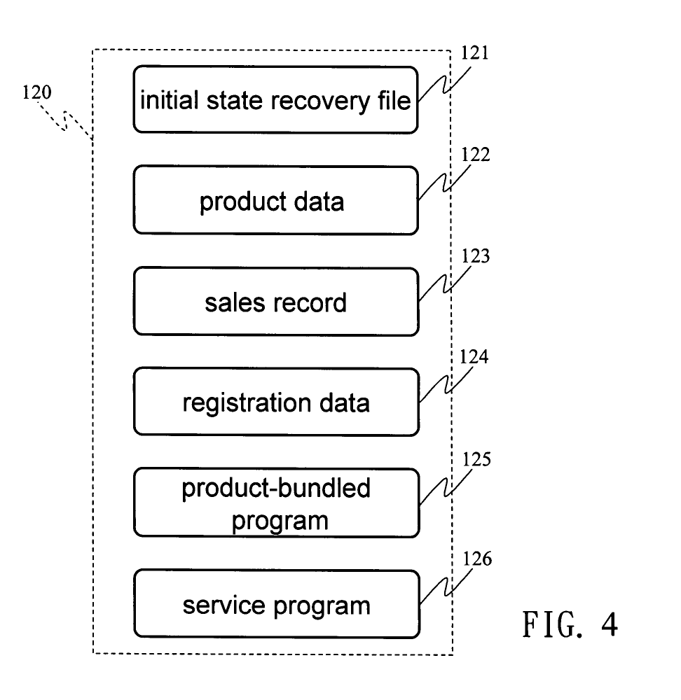

Referring to FIG. 4, it is a schematic view of the data stored in the storage memory 120, comprising: an initial state recovery file 121, which may be used when the personal computer 1 cannot be booted up because the program suffers an error or is infected with a computer virus, such that the computer can be booted up to an initial state again after being recovered by the initial state recovery file 121 through the executed recovery program; a product data 122 (such as the brand name, specification, manufacturer, and manufacturing time of each part); a sales record 123 (such as the name, address, telephone number, and purchasing data of the distributor and agent, and even information about whether or not the warranty period has been extended); a registration data 124 (such as the name, address, telephone number, and purchasing data of the consumer, and even information about whether or not the warranty period has been extended); a product-bundled program 125 (such as operating system install program, driver program, specification, etc.); and a service program 126, being executed automatically and displaying the system information display screen 80 and other information when the storage memory 120 is simulated as an MSC disk on the personal computer 1 after the computer is activated or the operating system is loaded.

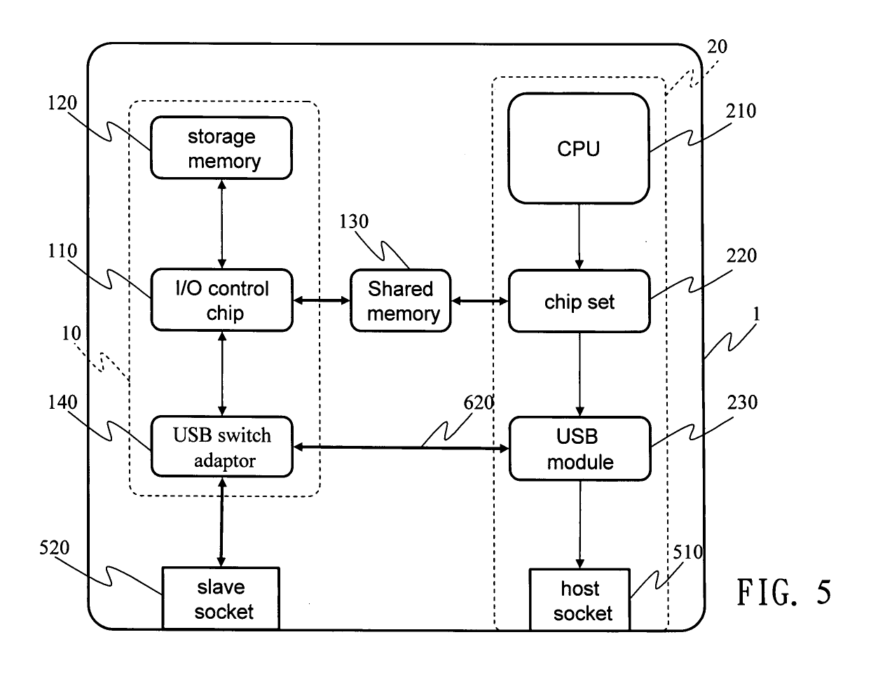

The present invention may be implemented at a local terminal and an external terminal of the personal computer 1. Thus, when the present invention is implemented at the local terminal, the data in the storage memory 120 may be displayed through the service program 126, and may also be displayed on the external computer 2 by simulating the storage memory 120 as an MSC disk on the external computer 2 via the slave socket 520 and executing the service program 126; and therefore, for integrating the two functions, please referring to FIG. 5, it is a systematic architectural view according to the most preferable embodiment of the present invention. Compared with the former two embodiments, a USB switch adaptor 140 is added in this embodiment, with one end being connected to the USB module 230 of the local terminal by using a second bus 620, and the other end being electrically connected to the slave socket 520, leaving the socket holes projecting outside the casing of the personal computer 1. When the personal computer 1 is packed, as there is an opening at the place corresponding to the socket holes in the box, the system information in the storage memory 120 may be accessed by inserting the USB cable 60 into the slave socket 520 via the opening without destroying the packing box of the personal computer 1 and without booting up the personal computer 1. To ensure that operations made from the external computer 2 terminal are performed by a legal user, the present invention may also provide a password for validation.

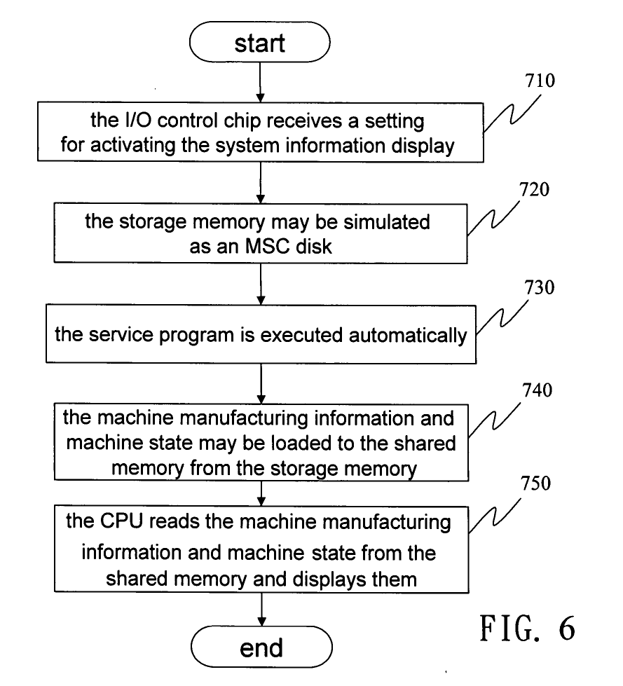

Therefore, the present invention may have two ways to activate the system information display service. The first way is to activate by pressing a service hotkey at the local terminal after the personal computer 1 has been booted up and enters the operating system display screen, as shown in FIG. 6. When the service hotkey is pressed, the I/O control chip 110 receives a setting for activating the system information display (step 710); the storage memory 120 may be simulated as an MSC disk (step 720), and the content stored inside may be displayed on the screen; then, the service program is executed automatically (step 730); the machine manufacturing information and machine state may be loaded to the shared memory 130 from the storage memory 120 (step 740); and finally, the CPU 210 reads the machine manufacturing information and machine state from the shared memory 130 and displays them (step 750).

As shown in FIG. 7, it is a schematic view of a display screen in an operating system according to the present invention. Taking a notebook computer as an example, the system information display screen 80 includes: machine information such as the brand name (e.g., ABC Brand), model (e.g., TLJ-312), serial number, CPU class, and manufacturing time; warranty information such as the warranty status, activation information, Expiration date and registration state with notes; and machine condition such as the wizard launched state (by external or internal mode), local state (e.g., machine power is off), and error messages between the software and hardware recorded by the operating system or BIOS (Basic Input/Output System) during operation of the personal computer 1.

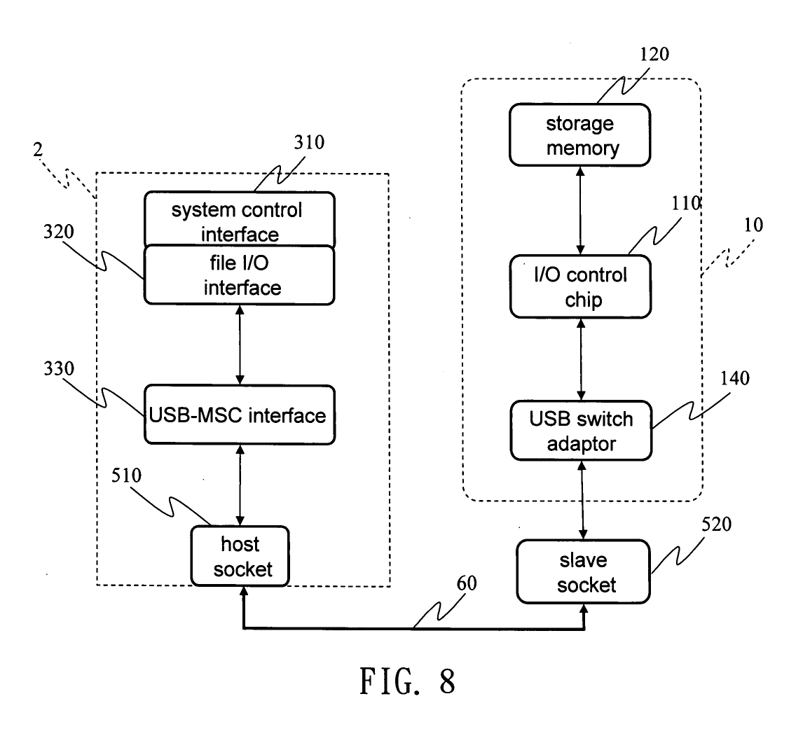

In the same way, the system information display screen 80 may also be activated by the external computer 2. Referring to FIG. 8, it is a schematic view of software architecture on the external computer 2, having a “USB-MSC interface” 330 for processing instructions, a host socket 510 connected to the slave socket 520 of the communication interface 10 through the USB cable 60, a system control interface 310 for systematically controlling the data management on the personal computer 1, and a file I/O interface 320 for reading the data stored in the storage memory 120, and therefore, through the present invention, the error messages stored in the shared memory 130 may be received and evaluated by the I/O control chip 110 on the external computer 2 through the USB cable 60.

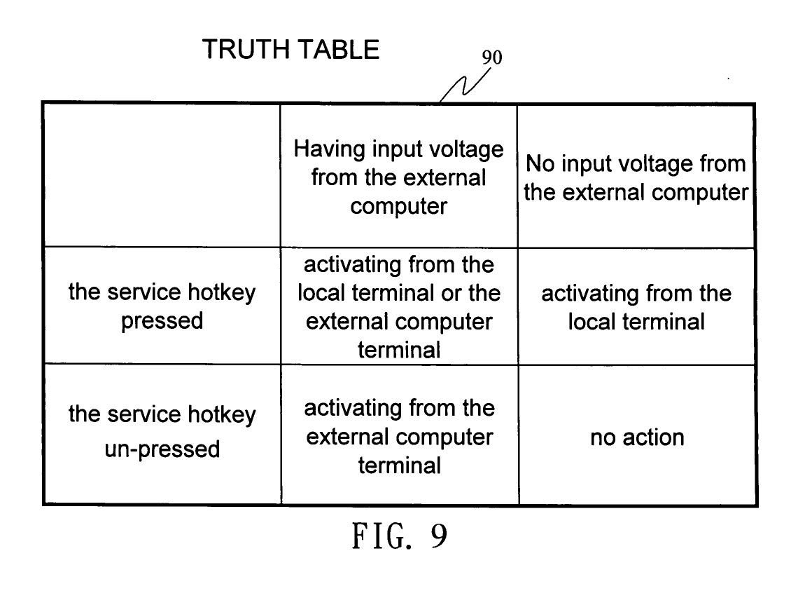

Because the two different ways for activating the system information display screen 80 cannot be executed simultaneously, only one can be selected; therefore, the USB switch adaptor 140 should determine with which one to perform the activation, depending on a truth table 90 as shown in FIG. 9. When the activation is performed with the service hotkey, whether or not there is input voltage from the external computer 2 on the slave socket 520 is determined. If the input voltage value is high, the I/O control chip 110 determines whether the storage memory 120 is simulated as an MSC disk at the local terminal or the external computer 2 terminal according to which one was activated later. If the input voltage value is low, it indicates that there is no input voltage from the external computer 2, and thus the activation is performed by the local terminal. In contrast, if the external voltage value is high, and no action of pressing the service hotkey is detected, the storage memory 120 is simulated as an MSC disk at the external computer 2 terminal; and if no action of pressing the service hotkey is detected and the input voltage value is low, no action should be made.

In summary, through the present invention, when a product is sold, distributors may obtain the system information (such as model, name of component, serial number, internal device information, etc.) of the personal computer 1 via a connection by the USB cable 60 through the slave socket 520 on the casing, without opening the packing box of the sold personal computer 1 or activating the power supply of the personal computer 1. And consumers may obtain the system information of the personal computer 1 to confirm whether or not the product content is consistent with what is recorded in the product specification without opening the computer case, thus maintaining the completeness of the fragile sticker at the case seam.

Besides this, in the case that the personal computer 1 cannot be booted up, users can read error messages stored in the shared memory 130 via the USB cable 60 with the aid of any external computer 2. Users may not even take the personal computer 1 to the distributor for repairing, but only send the error messages to the distributor or manufacturer repair center over a network, or inquiring on the phone, to obtain primary diagnosis of the computer. In such a way, users may avoid the inconvenience of rushing about and time-wasting, and the serviceman may further omit testing by evaluating the error messages, and fix the problem directly from the problem source, thus the speed of repairs may increase relatively.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A communication interface for use in a personal computer, disposed in a personal computer and electrically connected to a chip set on a motherboard with a first bus, for data transmission with the motherboard through the first bus, the communication interface comprising:
a storage memory, for storing a plurality of system information and a plurality of file data of the personal computer; and
an I/O control chip, with one end being electrically connected to the storage memory for simulating the storage memory as a MSC (Mass Storage Class), and the other end being electrically connected to a slave socket by means of which it may transmit data and obtain power through a USB (Universal Serial Bus) cable inserted from an external computer.

2. The communication interface for use in a personal computer as claimed in claim 1, wherein each of the file data may be any combination of a plurality of product-bundled programs, an initial state recovery file, a service program, and a plurality of specifications.

3. The communication interface for use in a personal computer as claimed in claim 2, wherein the service program is executed for activating display of a system information display screen when the personal computer has loaded an operating system.

4. The communication interface for use in a personal computer as claimed in claim 3, wherein the system information display screen comprises a plurality of machine manufacturing information and a plurality of machine states.

5. The communication interface for use in a personal computer as claimed in claim 3, wherein the system information display screen can be displayed on a screen of the external computer when the USB cable is inserted into the slave socket from the external computer and the personal computer can be in either an operation state or a shutdown state.

6. The communication interface for use in a personal computer as claimed in claim 2, wherein the display method of the system information display screen comprises the following steps:
receiving of a setting for activating a system information display service by the I/O control chip;
simulating the storage memory as the MSC and displaying it on a screen;
executing a service program automatically; and
loading each of the system information from the storage memory and displaying it.

7. The communication interface for use in a personal computer as claimed in claim 1, wherein the storage memory is a non-volatile memory packaged in the communication interface.

8. The communication interface for use in a personal computer as claimed in claim 1, wherein the I/O control chip can actively send a command to the personal computer to obtain each of the system information and store it in the storage memory.

9. A communication interface for use in a personal computer having one end being electrically connected to a shared memory, and the other end of the shared memory is electrically connected to a chip set on a motherboard of a personal computer, and the interface transmits data with the motherboard through the shared memory, and the communication interface comprises:
a storage memory for storing a plurality of system information and a plurality of file data of the personal computer; and
an I/O control chip, having one end being electrically connected to the storage memory for simulating the storage memory as an MSC, and the other end being electrically connected to a slave socket, by means of which it may transmit data and obtain power through a USB cable inserted from an external computer.

10. The communication interface for use in a personal computer as claimed in claim 9, wherein each of the file data may be any combination of a plurality of product-bundled programs, an initial state recovery file, a service program, and a plurality of specifications.

11. The communication interface for use in a personal computer as claimed in claim 9, wherein the system information is stored in the shared memory.

12. The communication interface for use in a personal computer as claimed in claim 10, wherein the service program is executed to display a system information display screen when the personal computer has loaded an operating system

13. The communication interface for use in a personal computer as claimed in claim 12, wherein the system information display screen comprises a plurality of machine manufacturing information and a plurality of machine states.

14. The communication interface for use in a personal computer as claimed in claim 13, wherein the system information display screen can be displayed on a screen of the external computer when the USB cable is inserted to the slave socket from the external computer and the personal computer can be in either an operation state or a shutdown state.

15. The communication interface for use in a personal computer as claimed in claim 12, wherein a display method of the system information display screen comprises the following steps:
receiving of a setting for activating a system information display service by the I/O control chip;
simulating the storage memory as the MSC and displaying it on a screen;
executing a service program automatically; and
loading each of the system information from the storage memory and displaying it.

16. The communication interface for use in a personal computer as claimed in claim 9, wherein the storage memory is a non-volatile memory packaged in the communication interface.

17. The communication interface for use in a personal computer as claimed in claim 9, wherein the I/O control chip can read each of the system information from the shared memory and store it in the storage memory.

18. The communication interface for use in a personal computer as claimed in claim 9, wherein the I/O control chip is used for reading a plurality of error messages generated during operation of the personal computer and stored in the shared memory.

19. The communication interface for use in a personal computer as claimed in claim 18, wherein each of the error messages can be transmitted to the external computer by the I/O control chip through the USB cable to be evaluated.

20. A communication interface for use in a personal computer having one end being electrically connected to a shared memory, and the other end of the shared memory is electrically connected to a chip set on a motherboard of a personal computer, and the interface transmits data with the motherboard through the shared memory, and the communication interface comprises:
a storage memory, for storing a plurality of system information and a plurality of file data of the personal computer;
an I/O control chip, with one end being electrically connected to the storage memory for simulating the storage memory as an MSC (Mass Storage Class), and the other end being electrically connected to a slave socket, by means of which it may transmit data and obtain power through a USB (Universal Serial Bus) cable inserted from an external computer; and
a USB switch adaptor, connected with the local terminal of the personal computer or the external computer, choosing one of them to communicate with the I/O control chip.

21. The communication interface for use in a personal computer as claimed in claim 20, wherein each of the file data may be any combination of a plurality of product-bundled programs, an initial state recovery file, a service program, and a plurality of specifications.

22. The communication interface for use in a personal computer as claimed in claim 21, wherein the service program is executed to display a system information display screen when the personal computer has loaded an operating system.

23. The communication interface for use in a personal computer as claimed in claim 22, wherein the system information display screen comprises a plurality of machine manufacturing information and a plurality of machine states.

24. The communication interface for use in a personal computer as claimed in claim 23, wherein the system information display screen can displayed on a screen of the external computer when the USB cable is inserted to the slave socket from the external computer and the personal computer can be in either an operation state or a shutdown state.

25. The communication interface for use in a personal computer as claimed in claim 22, wherein the display method of the system information display screen comprises the following steps:
receiving of a set for activating the system information display service by the I/O control chip;
simulating the storage memory as the MSC and displaying it on a screen;
executing a service program automatically; and
loading each of the system information from the storage memory and displaying it.

26. The communication interface for use in a personal computer as claimed in claim 20, wherein the storage memory is a non-volatile memory packaged in the communication interface.

27. The communication interface for use in a personal computer as claimed in claim 20, wherein the I/O control chip can send a command to obtain each of the system information from the personal computer and store it in the storage memory.

28. The communication interface for use in a personal computer as claimed in claim 20, wherein the USB switch adaptor selects an object to communicate with according to the state of a truth table.

29. The communication interface for use in a personal computer as claimed in claim 20, wherein the system information is stored in the shared memory.

30. The communication interface for use in a personal computer as claimed in claim 20, wherein the I/O control chip is used to read a plurality of error messages generated during operation by the personal computer and stored in the shared memory.

31. The communication interface for use in a personal computer as claimed in claim 30, wherein each of the error messages may be transmitted to the external computer by the I/O control chip through the USB cable to be evaluated.
